(19) United States
(12) Patent Application Publication
(10) Pub. No.: US 2009/0308412 A1
(43) Pub. Date: Dec. 17, 2009

(54) STORAGE TANK CLEANING METHOD AND APPARATUS

(75) Inventor: RANDY J. DIXON, Billings, MT (US)

Correspondence Address: SHERIDAN ROSS PC, 1560 BROADWAY, SUITE 1200, DENVER, CO, 80202, US

(73) Assignee: DIXON PUMPS, INC., Billings, MT (US)

(21) Appl. No.: 12/486,530

(22) Filed: Jun. 17, 2009

Related U.S. Application Data
(60) Provisional application No. 61/073,297, filed on Jun. 17, 2008.
(60) Provisional application No. 61/078,204, filed on Jul. 3, 2008.

(51) Int. Cl. B08B 9/093

(52) U.S. Cl. 134/10; 134/111

(57) ABSTRACT

A tank cleaning apparatus and method is provided that employs a series of associated canisters that house filters of various sizes. Fluid flow to each canister may be selectively ceased so that the filter contained therein may be replaced or cleaned while allowing tank cleaning to be continued.

This application claims the benefit of U.S. Provisional Patent Application Ser. No. 61/073,297, filed Jun. 17, 2008 and U.S. Provisional Patent Application Ser. No. 61/078,204, filed Jul. 3, 2008, the entire disclosures of each are incorporated by reference herein.

### FIELD OF THE INVENTION

The present invention relates generally to devices and methods for cleaning storage tanks. More specifically, embodiments of the present invention relate to devices and methods for cleaning volatile liquid storage tanks in a manner that allows for potentially valuable tank contents to be salvaged.

### BACKGROUND OF THE INVENTION

Current methods of cleaning and evacuating volatile liquid storage tanks include significant time and monetary investments. Most cleaning operations are commenced when a tank contains some minimal amount of material, waste, or dirt that has collected within the storage tank. By way of example only, this amount may represent material collected along the inner surfaces of the storage tank and eight to twelve inches of material positioned along the bottom of the storage tank, three to five inches of which may be considered waste. Typically, storage tanks must be taken offline for periods as long as two weeks while manual cleaning is conducted. These periods of downtime often result from the need to uncover and access subterranean storage tanks so that humans and large-scale equipment may obtain access, perform potentially dangerous cleaning operations, and restore the storage tank and the overlying surface to their original conditions. In addition to the costs associated with the tanks being unavailable, service costs, and costs associated with uncovering and resurfacing storage tank locations, these methods also present safety risks. Even with safety measures in place, it is undesirable to place humans within a confined space coupled with the presence of volatile (i.e., flammable) and hazardous materials.

Furthermore, traditional methods of cleaning storage tanks typically involve disposing of hazardous, contaminated materials uncovered during cleaning that may otherwise have value if filtered and cleaned. As some storage tanks contain petroleum based products, the disposal of “waste” materials may represent significant costs to the operator or owner of the tank. Further, disposing “waste” material that in many instances contains valuable resources is environmentally unsound.

### SUMMARY OF THE INVENTION

It is one aspect of the present invention to provide an apparatus and method for cleaning storage tanks without requiring human entry into storage tanks. In one embodiment of the present invention, a method and apparatus is presented whereby a series of vacuum and pressure canisters, operating either independently or in concert, draw contents from within the storage tank, filter and/or “polish” the contents, and returns the treated contents through an impingement cleaning nozzle that is used to forcibly remove debris from the surface of the storage tank (i.e., by way of high pressure and high mass flow). The treated contents that are used to remove debris is thus subjected to further filtration and polishing. Alternatively, the treated contents may be stored, whereby removal of debris is performed by cleaning solvents.

Another aspect of the present invention is to provide a method and apparatus that allows storage tanks to be cleaned while minimizing waste and maximizing the amount of material that may be reused or recycled. In one embodiment of the present invention, a method and apparatus is presented whereby materials that would typically be considered waste are subjected to various degrees of filtration and polishing in order to produce a useful or valuable product.

Another aspect of the present invention is to provide a method and apparatus that allows for continuous operation and tank cleaning by utilizing a system whereby one or more canisters may be removed from operation without requiring a complete disruption of the cleaning process. Therefore, in one embodiment of the present invention, a plurality of vacuum and pressure canisters are provided whereby canisters may either operate in series or in parallel so that one or more canisters may be selectively removed from operation. In one embodiment, internal pressure readings of the canisters notify a technician that a filter positioned within the canister requires replacement or service. In this embodiment, canisters in need of cleaning or maintenance may be removed in isolation while the remainder of the apparatus continues to perform storage tank cleaning operations.

Thus, it is one aspect of the present invention to provide a device for cleaning contaminated volatile material from the storage tank that employs a vacuum pump with an intake connected to a vacuum line which draws materials from the tank. A plurality of canisters are also connected to the vacuum pump which are designed to accommodate negative and positive pressures and house filtering devices are also included. Further, a bypass system comprised of valves connects the plurality of canisters and allows for one or more of the plurality of canisters to be deactivated without requiring the device to be entirely shut down. The filtered of cleaned materials are returned from the device to the tank by way of a discharge hose that is connected to a nozzle, the nozzle acting as an both a means of returning materials to the storage tank and as an impingement cleaning device. Some embodiments of the present invention also employ an auxiliary tank separate from the storage tank for supplying solvents or other materials to the device and/or storage.

It is still yet another aspect of the present invention to provide a method for cleaning contaminated volatile material from a storage tank, comprising: extracting contaminated volatile materials from the storage tank through the use of a vacuum line and pump; directing the contaminated volatile materials through a plurality of canisters which house filtration devices; isolating at least one canister of the plurality thereof with a bypass system that includes valves when the internal canister pressure reaches an unacceptable value; and returning treated volatile material to the storage tank where the treated volatile materials may be used to further clean the storage tank by impingement cleaning and subjected to further filtration.

The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is an elevation view of one embodiment of the present invention;

FIG. 2 is a top plan view of one embodiment of the present invention;

FIG. 3 is a schematic showing the inlet filtration loop of one embodiment of the present invention;

FIG. 4 is a schematic showing the outlet filtration loop of one embodiment of the present invention;

FIG. 5 is a schematic showing of one embodiment of the present invention that employs two canisters; and

FIG. 6 is a cross sectional view of a typical storage tank for which embodiments of the present invention may be utilized.

To assist in the understanding of the present invention the following list of components and associated numbering found in the drawings is provided herein:

| Number | Component |
|---|---|
| 2 | Tank Cleaning Apparatus |
| 4 | Pump |
| 6 | Skid |
| 8 | Vacuum Canisters |
| 10 | Pressure Canisters |
| 12 | Vacuum Gauges |
| 13 | Pressure Gauges |
| 14 | Valves |
| 16 | Contaminated Tank |
| 18 | Typical fill level at cleaning |
| 20 | Impingement Cleaning Nozzle |
| 22 | Inlet line |
| 24 | Vacuum line |
| 26 | Intake holes |
| 28 | Coil spring |
| 30 | Tank ports |
| 32 | Manhole |
| 36 | Manifold |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

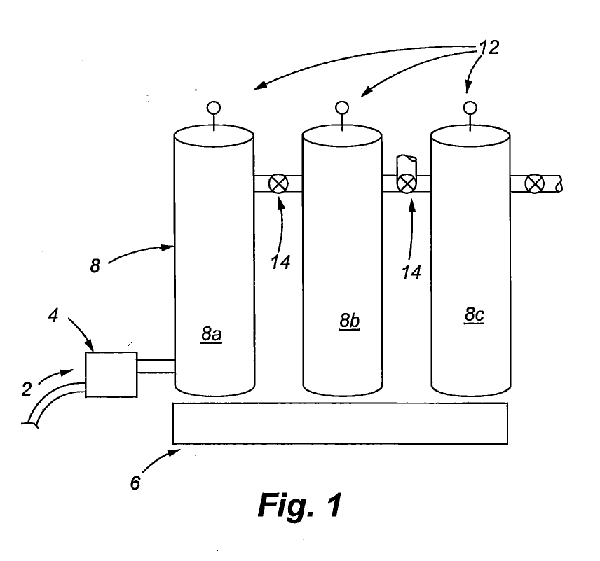

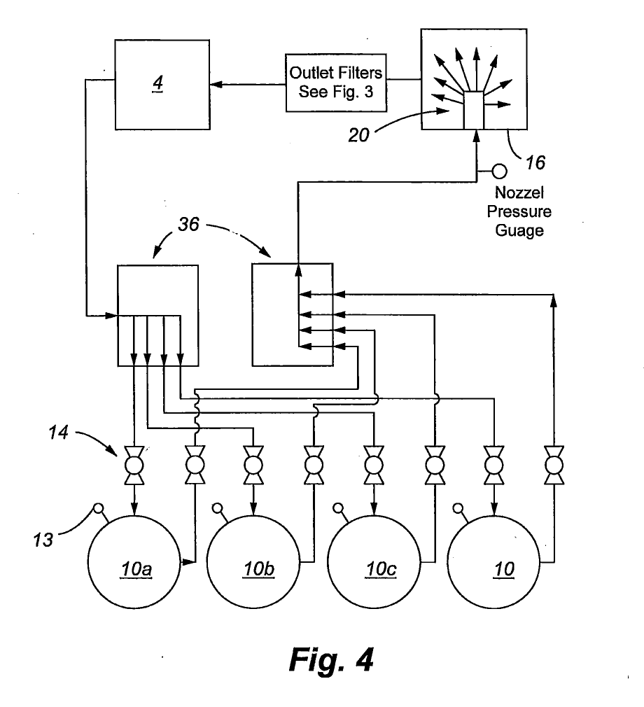

FIGS. 1-6 depict various embodiments of the present invention whereby volatile liquid storage tanks are cleaned, contents thereof filtered, and any valuable materials are salvaged.

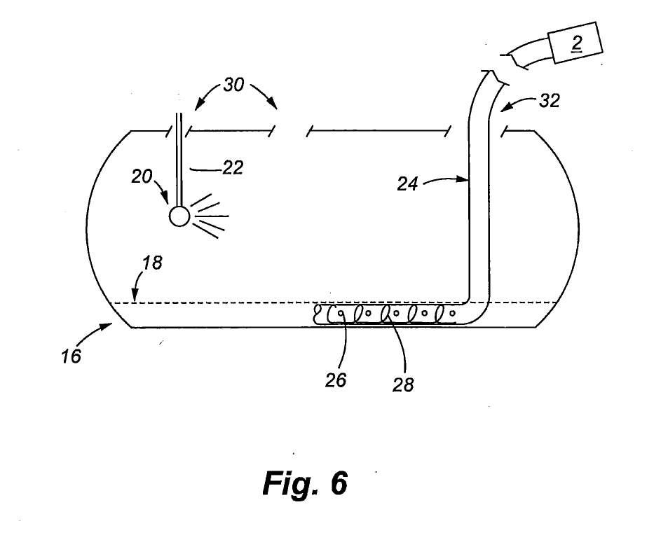

More specifically, FIGS. 1-4 show one embodiment of a tank cleaning apparatus 2 comprising suction or vacuum canisters 8 representing the first phase of the cleaning process. In order to extract and obtain material from a storage tank, a pressure differential is created that draws material from the tank through an inlet and into a first vacuum canister 8a. Material comprising cleaning solution, petroleum based products, debris, or other similar substances are drawn through a hose that is positioned along a bottom edge of the storage tank (see FIG. 6). Preferably, the pressure differential is created by a vacuum pump 4 that generates a negative pressure in a first vacuum canister 8a and induces flow from the tank through the apparatus 2. The pump 4 may range in power from about 1.0-15.0 horsepower depending on the size of the storage tank to be cleaned and the required pressure required to remove debris. Preferably, materials to be treated will be initially drawn through a first canister 8a, which contains a large scale filter. Such large scale filters may take the form of a screen or other high porosity filter that serves to remove large scale debris from the material. After passing through the first canister 8a, the material requires further cleaning and is directed through a second vacuum canister 8b that performs a similar function to that of the first canister, but utilizes a lower porosity filter. For example, as opposed to a screen filter, the second vacuum canister 8b may employ a 300 μm bag filter to achieve a higher level of filtration. In applications where these filtration systems will be treating hazardous or corrosive materials, filter elements should preferably be constructed of a synthetic or polyester material that are more suited to withstand such materials. The second vacuum canister 8b is interconnected with yet another vacuum canister 8c that may be used for further filtration of the storage tank materials. The third vacuum canister 8c may house an even more refined filter or may be used as a redundant filter to the second vacuum canister 8b. The third vacuum canister 8c therefore provides the advantages of being used as an additional filtration device in series with the first two vacuum canisters or may be used as a redundant measure to allow for either the first canister 8a or second canister 8b to be taken offline without halting the cleaning process.

In order to achieve this redundancy, the apparatus 2 is equipped with valves 14 that allow a user to selectively divert tank materials along the preferred filtration path. For example, if it is desirable to allow materials to pass through all three vacuum canisters 8, the valves 14 can be positioned so as to allow passage of tank materials through all three canisters in series. However, when less filtration is desired or when one or more canisters requires removal from operation for cleaning, replacement, or maintenance, the valves 14 may be selectively closed to prevent the flow of material from the canister or canisters to be removed. To facilitate this process, each vacuum canister is provided with independent vacuum gauges 12 to display the internal pressure thereof. For a given pump power rating, the vacuum pressure displayed by these gauges will correspond to the amount of material accumulated on each filter. When the pressures displayed by gauges 12 rises to an undesirable level, the canister should be temporarily removed from operation in order to clean, replace, or otherwise service the filtration system contained therein. The plurality of vacuum canisters 8 combined with the control valves 14 allows for the removal of filters without interrupting cleaning operations, which saves time and expenses. One of ordinary skill in the art will recognize a variety of devices that may be employed to achieve this goal. In one embodiment of the present invention, mechanical ball valves are used to control flow through manual operation. In another embodiment, an automated system may be substituted for manual reading and control of the gauges and valves. For example, sensors may be used to provide information associated with canister vacuum pressure directly to valves controlled by solenoids or other devices to automatically halt flow to a canister when a specified unacceptable pressure is reached in that canister. Thereafter, a feedback signal may be utilized to indicate to a user that a canister has been deactivated and requires attention.

In one embodiment of the present invention, the downstream flow path from the vacuum canisters 8 can be diverted through a nozzle to further clean the interior of a tank and be subjected to further filtration according to the methods and devices described herein. For example, the flow valves 14 of one embodiment direct material that has been passed through vacuum canisters through a sight glass and return the material to the tank where it may be used for further impingement cleaning of the tank. If further tank cleaning or filtration is not desired, the material may simply be returned to the initial tank or a separate tank for storage.

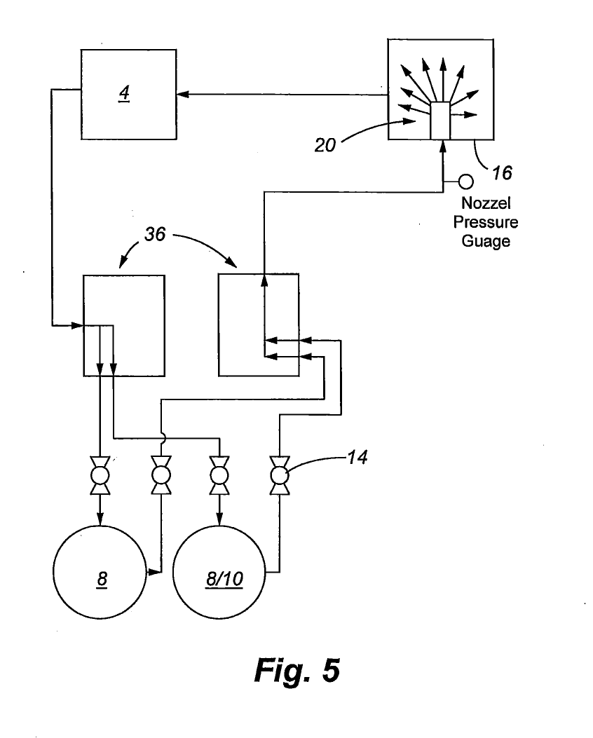

One of ordinary skill in the art will recognize that number, orientation, size, or shape of the canisters is immaterial to performing their filtration functions. Therefore, a variety of devices capable of withstanding positive or negative pressures may be substituted for the elements depicted in FIG. 1. Furthermore, although the foregoing description involves a plurality of three vacuum canisters, it should be recognized that the current invention is not limited to such an embodiment. For example, one embodiment employs two (see FIG. 5) where at least one canister may be used for polishing, which will be described below. The objectives of efficiently filtering materials and selectively removing one or more canisters from operation without halting the entire process may be equally well accomplished with any number of canisters.

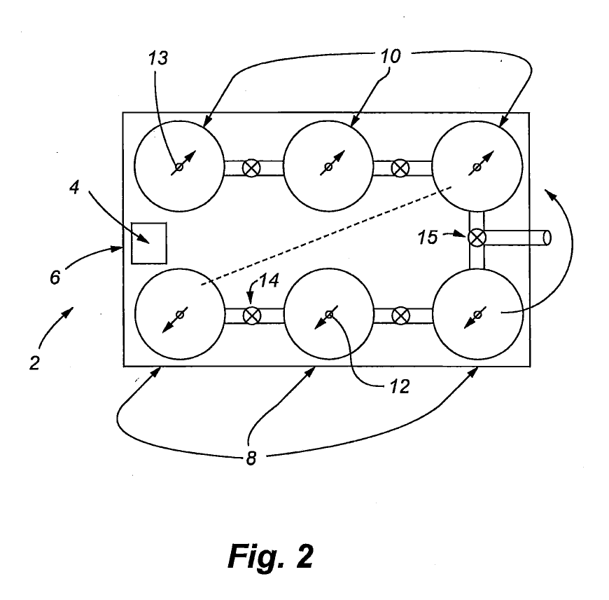

FIG. 2 is a plan view of the present invention that shows the pressure canisters 10 in addition to the previously described vacuum canisters 8. Pressure canisters 10 act as mechanisms of further filtering that typically act to refine or “polish” the material after the tank has been cleared of large scale debris by the vacuum canisters. In order to achieve this goal, the pressure canisters 10 utilize finer filtration devices. For example, in one embodiment, a first and second pressure canister pass tank materials through filters on the order of 100 μm while a third canister filters particulate down to 10 μm. This aspect of the present invention allows for the cleaning and refinement of storage tank contents such as diesel, gas, and other potentially valuable materials in addition to the cleaning of the tank itself. By providing this higher level of filtration and polishing, storage tank contents including but not limited to fuels can be returned to a commercially viable state. One method of performing this function is to cycle the materials through the apparatus and return them to the tank. Alternatively, valuable materials may be diverted to a separate tank or storage device either for storage or further treatment. In one embodiment, once materials have been routed through the pressure canister(s), they may be returned to the tank through the sight glass and outlet for storage or further cleaning. The ability to select between bypassing the pressure canister or utilizing both the suction canister in series with the pressure canister(s) allows for the pressure canister to be taken offline for cleaning, replacement, or maintenance while continuing filtering operations and avoiding costly downtime.

In one embodiment of the present invention, the pressure canisters 10 are used in series with the screen filter of the first vacuum canister 8a, but not with the subsequent vacuum canisters. Ideally, large scale filtering operations have been completed before tank material polishing has begun. However, one of ordinary skill in the art will recognize that it is also a feature of the invention that materials may enter the polishing stage directly from the coarse filtering vacuum canisters. In order provide for this feature of selectable flow direction, previously discussed valves 14 in addition to an exit valve may be positioned to divert flow accordingly.

In addition to further refining materials, pressure canisters 10 are interconnected in a similar manner as described above with respect to the vacuum canisters 8 and equipped with multi-directional flow valves 14. As each canister is supplied with a pressure gauge that performs the similar function as the aforementioned vacuum gauges, canisters may be selectively deactivated from the cleaning process and removed for filter replacement, maintenance, or cleaning when a threshold pressure value is exceeded. This process of removing pressure canisters from operation may also be achieved by the previously discussed automated methods.

One embodiment of the present invention further includes the structure and ability to house spent or dirty filters within the apparatus. When filters are removed from operation, they may be placed in interior receptacles, canisters, or storage means where they may be allowed to drain, be subjected to manual washing, or be subjected to any number of automated cleaning operations. One of ordinary skill in the art will recognize that although one embodiment performs these tasks within the apparatus, the location of receptacles or storage means is not critical to the cleaning process or processes and may be located in a variety of positions with respect to the apparatus.

In one embodiment of the present invention, the tank cleaning apparatus 2 is contained by a structure or skid 6 to facilitate transportation of the apparatus to remote sites. However, one of ordinary skill in the art will recognize that it is not essential to contain the apparatus 2 in this manner in order to achieve the goals and objectives discussed herein.

FIG. 6 shows a cross sectional view of a typical storage tank 16 that the present invention may be used in conjunction with. Most cleaning operations are commenced when a storage tank contains some minimal amount of material, waste, or dirt 18 that has collected on the inner surface thereof, usually at the bottom. By way of example only, this amount may represent eight to twelve inches of material, three to five inches of which may be considered waste. Typically, such a storage tank will have prefabricated holes or ports 30, 32 for accessing the tank interior. The present invention is designed to utilize these ports to insert and extract material. A first port 30 is shown as a receiver for materials entering the tank. In one embodiment, a line 22 extending from the apparatus 2 carries materials to within the tank 16 where it may then be directed through a nozzle 20 within the tank that propels materials in a manner that will provide desired cleaning attributes. In one embodiment, solvent or fluid received from the canisters (i.e. previously suctioned from the tank) is directed to a nozzle 20 that incrementally treats the inner surface of the tank by impingement cleaning. The nozzle 20, which may be made by Gamajet™, supplies high pressure and mass flow to remove debris from the inner surface of the tank. For example, the nozzle 20 may that disclosed in U.S. Pat. Nos. 6,561,199, 6,123,271, 5,954,271, 7,063,274, 5,823,435, 6,460,533, and U.S. Patent Application Publication No. 2008/0142042, the entire disclosures of which are incorporated by reference herein. Preferably, the nozzle 20 operates as a rotatable impingement cleaning device. In a preferred embodiment of the present invention, such a nozzle 20 may supply cleaning material at about 70-100 pounds per square inch at a flow rate of about 25-50 gallons per minute and cut a swath of approximately 1.0 inch through tank materials. Such a device provides for sufficient coverage and cleaning power to obviate the need for human entry and manual cleaning from within the tank. In one embodiment of the present invention, this nozzle 20 cleans the entirety of the interior of the tank by variably changing position under its own pressure. In another embodiment, the nozzle 20 may be controlled through human interaction. For example, the nozzle 20 may be mechanically or electronically controlled by a user outside of the tank in order to clean the desired area. Another embodiment of the present invention provides for the use of a plurality of nozzles to perform impingement cleaning of storage tank interiors. For example, when a tank is sufficiently large as to require more than one inlet nozzle, a second may be inserted into the tank, preferably through a port or manhole at a distant location from the first, and perform similar cleaning functions. Materials diverted through the inlet line or lines 22 may include cleaned and cycled tank material, such as petroleum products, which act as solvents and are useful in cleaning the interior of a tank while being repeatedly cycled in an essentially closed loop process as discussed herein. Alternatively, these materials may include additional solvents supplied from an additional tank or storage device separate from the storage tank that are effective at removing waste from the storage tank.

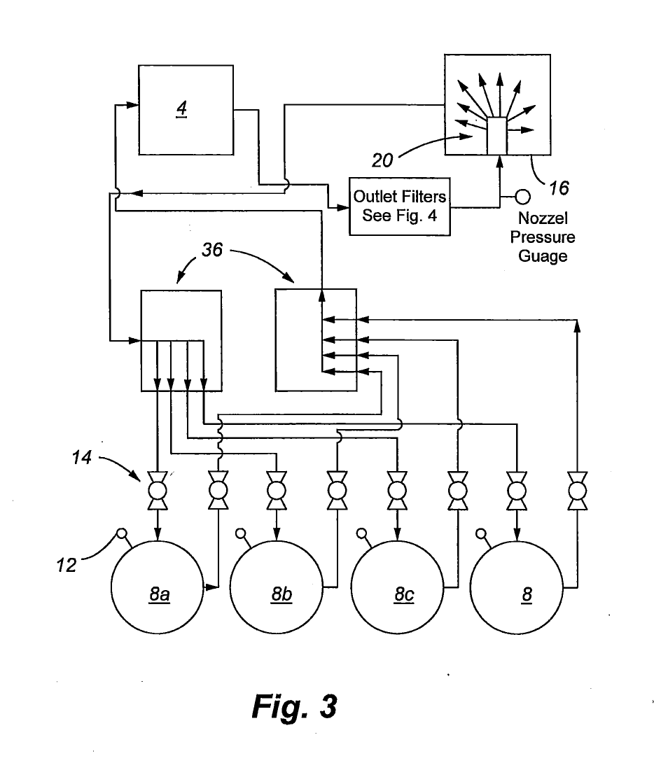

The removal of material from the tank is achieved by means of a vacuum line 24 which enters through a hole or manhole 32 and preferably extends along the bottom of the tank 16 and is at least partially submerged in the material to be removed 18. Typical ribbed or woven hosing is generally suitable for this purpose, with the exception that their coiled nature prevents linear distribution of the hose along the tank bottom as shown in FIG. 3. Therefore, an aspect of the present invention is to provide for a mechanism within the hose 28 to allow for flexibility upon entry to the tank as well as preventing the hose from coiling or retracting once it is inserted. Such a mechanism may involve a coil spring applied to the interior or exterior hose diameter. Furthermore, a vacuum hose 24 is equipped with a series of entry points 26 that may be used in conjunction with or in lieu of a main orifice at the end of the vacuum hose 24. The purpose of these entry points 26 is to promote laminar flow into the hose 24 and reduce the risks of system failure that may result from a single entry point becoming obstructed with debris.

In addition the contaminated storage tank 16, one embodiment of the present invention also an additional receptacle or tank for cleaning materials or solvents. Frequently, tank contents 18 will require the addition of solvents or other materials to be removed from the tank 16 and subjected to filtration by the apparatus 2. Therefore, the apparatus 2 may both draw from and deposit materials in either the storage tank to be cleaned or the additional tank. Preferably, the apparatus 2 draws the cleaning materials or solvents from the additional tank and deposits the solvents within the storage tank until an acceptable amount is deposited. Thereafter, the additional tank is disconnected from the apparatus 2 and cleaning and filtering operations are conducted on the storage tank without additional solvent input. One of ordinary skill in the art will recognize, however, that solvents from the additional tank may be continuously added while tank cleaning operations are conducted.

Another aspect of the present invention is to provide a method and apparatus for visually inspecting the interior of a storage tank to provide a user with information regarding tank contents and cleanliness. Therefore, in one embodiment of the present invention, a camera or similar monitoring device is inserted into one of the ports of a storage tank and provides visual information to a user external to the tank. One of ordinary skill in the art will recognize a variety of devices that may be used to achieve this goal, including but not limited to fiber optic cameras, convention video cameras, mirrors, and still-photography. While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. A device for cleaning contaminated volatile material from a storage tank, comprising:
a vacuum pump with an intake connected to a vacuum line which draws materials from a tank;
a plurality of canisters connected to said vacuum pump which are designed to accommodate negative and positive pressures and house filtering devices;
a bypass system comprised of valves which connects said plurality of canisters and allows for one or more of said plurality of canisters to be deactivated without requiring said device to be shut down;
a discharge hose to return filtered or cleaned materials from said device to the tank which is connected to a nozzle, said nozzle acting as an both a means of returning materials to the storage tank and as an impingement cleaning device; and
an auxiliary tank separate from the storage tank for at least one of: supplying solvents or other materials to said device and storage.

2. The device of claim 1 wherein said plurality of canisters includes a first canister possessing a negative pressure and a second canister possessing a positive pressure, wherein the said first canister draws in and filters materials taken from within the storage tank and said second canister further filters and provides for return flow of treated materials to the storage tank.

3. A method for cleaning contaminated volatile material from a storage tank, comprising:
extracting contaminated volatile materials from the storage tank through the use of a vacuum line and pump;
directing the contaminated volatile materials through a plurality of canisters which house filtration devices;
isolating at least one canister of the plurality thereof with a bypass system that includes valves when the internal canister pressure reaches an unacceptable value; and
returning treated volatile material to the storage tank where the treated volatile materials may be used to further clean the storage tank by impingement cleaning and subjected to further filtration.
